(19) United States
(12) Patent Application Publication
(10) Pub. No.: US 2006/0182302 A1
(43) Pub. Date: Aug. 17, 2006

(54) SPEAKER WITH INTEGRATED VIBRATION SYSTEM

(75) Inventor: Noboru Onodera, Shizuoka (JP)

Correspondence Address: FOLEY AND LARDNER LLP;SUITE 500, 3000 K STREET NW, WASHINGTON, DC, 20007, US

(73) Assignee: MINEBEA CO., LTD.

(21) Appl. No.: 11/276,057

(22) Filed: Feb. 10, 2006

(30) Foreign Application Priority Data
Feb. 15, 2005 (JP) P.2005-037498

(51) Int. Cl. H04R 1/00

(52) U.S. Cl. 381/397

(57) ABSTRACT

A speaker is provided which includes a magnetic circuit, a voice coil bobbin having a voice coil wound therearound, and a vibration system having a spider and a diaphragm combined into an integrated component. In the speaker described above, the spider is located within the voice coil bobbin, fixedly attached to the center portion of the magnetic circuit, and has its outer circumference attached to the voice coil bobbin so that the voice coil wound around the voice coil bobbin is suspended in a magnetic gap of the magnetic circuit. Since the spider and the diaphragm are integrated into one component reducing the number of components, the speaker has its structure simplified therefore reducing the production cost, and at the same time, the speaker, even if the diaphragm has a small diameter, achieves a wide reproduction frequency bandwidth and withstands a large power input thus providing a high reliability.

### BACKGROUND OF THE INVENTION

1. Field of the Invention

The present invention relates to a speaker for use in various audio equipments, and more particularly to a speaker with a small diameter.

2. Description of the Related Art

Dimensional scale-down of audio equipments requires downsizing of speakers, and this inevitably suggests reduction of the outer diameter of a diaphragm. The reduction of the diaphragm diameter forces reduction of the outer diameter of a spider which has its inner circumference attached to the outer circumference of a voice coil bobbin so as to suspend a voice coil in a magnetic gap of a magnetic circuit. The reduction of the spider diameter, however, increases the stiffness of the spider and consequently raises the lowest resonance frequency of the speaker, thus narrowing the reproduction bandwidth.

To deal with the problem described above, in some small speaker, a spider is disposed inside a voice coil bobbin such that the outer circumference of the spider is attached to the inner circumference of the voice coil bobbin, and that the inner circumference of the spider is attached to the center portion of a magnetic circuit, whereby the stiffness of the spider is prevented from increasing.

For examples Japanese Patent Application Laid-Open No. 2004-221691 discloses a speaker which includes a dome diaphragm, a voice coil bobbin, a spider, and a magnetic circuit, wherein the dome diaphragm has a dome portion, a first fixing structure provided so as to extend from the outer circumference of the dome portion along the inner circumference of the voice coil bobbin, and a second fixing structure provided so as to extend orthogonally from the outer circumference of the first fixing structure, and wherein the spider is disposed within the voice coil bobbin such that the inner circumference of the spider is attached to the magnetic circuit, and that the outer circumference of the spider is attached to the inner circumference of the dome portion of the diaphragm and to the inner circumference of the voice coil bobbin.

In the speaker described above, however, the diaphragm, spider, and surround are discrete from one another as shown in FIG. 1 of the aforementioned Japanese Patent Application Laid-Open No. 2204-221691, and therefore the number of components remains unchanged compared to conventional speakers thus providing no advantage in terms of cost reduction.

### SUMMARY OF THE INVENTION

The present invention has been made in the light of the above circumstances, and it is an object of the present invention to provide a small-size speaker, in which at least a diaphragm and a spider are integrally formed into one component with a simplified structure for reducing the number of components thereby achieving reduction in production cost, and which, while using a small-diameter diaphragm realizes a broad reproduction bandwidth, withstands a large power input, and provides a high reliability. Also, the present invention is not required to provide the advantages described above, and an illustrative, non-limiting embodiment of the invention may provide different advantages.

In order to achieve the object described above, according to one aspect of the present invention, there is provided a speaker which includes: a magnetic circuit; a voice coil bobbin having a voice coil wound therearound; and a vibration system having a spider and a diaphragm, which are combined into an integrated component such that the diaphragm extends radially outwardly from the outer circumference of the spider. In the speaker described above, the spider is located within the voice coil bobbin, the outer circumference of the spider is fixed to the voice coil bobbin, and the center area of the spider is fixed to the center portion of the magnetic circuit so that the voice coil wound around the voice coil bobbin is suspended in a magnetic gap of the magnetic circuit.

In the one aspect of the present invention, the outer circumference of the spider may be engageable with the voice coil bobbin.

In the one aspect of the present invention, the diaphragm may have a cone configuration.

In the one aspect of the present inv, the vibration system may further integrally include a surround extending radially outwardly from the outer circumference of the diaphragm so as to connect between the diaphragm and a part of a frame of the speaker.

In the one aspect of the present invention, the spider, the diaphragm, and possibly also the surround may be integrally formed of either a synthetic resin, a resin film, a natural fiber, or a synthetic fiber.

In the one aspect of the present invention, the spider, the diaphragm, and possibly also the surround may be integrally formed of a breathable material with at least the diaphragm structured non-breathable.

In the one aspect of the present invention the top surface of the diaphragm may be covered by the outer periphery of a dust cap of the speaker, the dust cap being made of a non-breathable material.

In the one aspect of the present invention, either the top surface or the bottom surface of the diaphragm may be covered by an inner flange of a surround made of a non-breathable material.

In the one aspect of the present invention, either the top surface or the bottom surface of the diaphragm may be sealed by a rubber-based resin.

In the one aspect of the present invention, a fixing structure having a hollow circular cylindrical configuration with a bottom lid may be formed at the center of the bottom of the spider.

In the one aspect of the present invention, an aperture may be formed at the center of the bottom lid of the fixing structure, so that the spider is securely fixed to the center portion of the magnetic circuit by means of an adhesive which is applied between the magnetic circuit and the bottom lid of the fixing structure, and which flows partly into the fixing structure through the aperture of the bottom lid.

In the one aspect of the present invention, the spider may have, at its center area, a plane area which has an aperture formed at its center.

In the one aspect of the present invention, the spider may be fixedly attached via a support member to the center portion of the magnetic circuit by leveraging the plane area of the spider and/or the aperture formed at the plane area.

According to another aspect of the present invention, a speaker includes: a magnetic circuit; a voice coil bobbin having a voice coil wound therearound; and a vibration system including a spider of multi-arm structure and a diaphragm, which are combined into an integrated component such that the diaphragm extends radially outwardly from the outer circumference of the spider. In the speaker described above, the spider is located within the voice coil bobbin, a fixing structure to be fixedly attached to the center portion of the magnetic circuit is formed at the center of a bottom of the spider, and an engaging area to engage with the voice coil bobbin is formed at the outer circumference of the spider.

In the other aspect of the present invention, the vibration system may further integrally include a surround extending radially outwardly from the outer circumference of the diaphragm.

Accordingly, in the speaker according to the present invention, since the vibration system integrally includes a spider and a diaphragm to be formed together at one time, the number of components can be reduced.

Since the vibration system is structured such that the center area and the outer circumference of the spider are fixedly attachable to the magnetic circuit and the voice coil bobbin, respectively, the spider can be simply, easily and securely attached to the magnetic circuit while the voice coil wound around the voice coil bobbin is duly suspended in the magnetic gap of the magnetic circuit. Consequently, improvement of the speaker productivity, as well as reduction of the number of components, can be achieved.

If the vibration system further integrally includes a surround to be formed with the spider and the diaphragm, the number of components can be further reduced. This enables a small-diameter speaker to be assembled very easily therefore improving productivity and also achieving cost reduction.

When the integrated component including the spider, the diaphragm, and possibly also the surround is made of a breathable material, the diaphragm, which preferably is structured non-breathable, is to be totally covered by the outer periphery of a dust cap made of a non-breathable material or by a part of a surround made of a non-breathable material, or is to be totally sealed, whereby sound quality degradation is prevented, and a speaker of good quality is provided.

Since the fixing structure shaped in a hollow circular cylinder having a bottom lid with an aperture at the center is integrally formed at the center of the bottom of the spider, an adhesive applied between the upper surface of the magnetic circuit and the bottom lid of the fixing structure flows partly into the fixing structure through the aperture of the bottom lid and is hardened, whereby the spider can be securely fixed to the magnetic circuit, and a highly reliable speaker can be provided.

And, alternatively the vibration system can be secured to the magnetic circuit such that the spider is fixedly connected to the center portion of the magnetic circuit via the support member by means of the plane area formed at the spider and/or the aperture formed at the plane area. Thus, highly reliable speaker can be provided.

### BRIEF DESCRIPTION OF THE DRAWINGS

FIG. 1 is a cross-sectional view of a speaker according to a first exemplary, non-limiting embodiment of the present invention;

FIG. 2 is an enlarged cross-sectional view of a relevant portion of one vibration system in the speaker of FIG. 1;

FIG. 3 is an enlarged cross-sectional view of a relevant portion of another vibration system in the speaker of FIG. 1;

FIG. 4 is an enlarged cross-sectional view of a relevant portion of still another vibration system in the speaker of FIG. 1;

FIG. 5 is a cross-sectional view of a vibration system in a speaker according to a second exemplary, non-limiting embodiment of the present invention;

FIG. 6 is a top plan view of a vibration system in a speaker according to a third exemplary, non-limiting embodiment of the present invention;

FIG. 7 is a cross-sectional view of the vibration system of FIG. 6; and

FIG. 8 is a cross-sectional view of a speaker according to a fourth exemplary, non-limiting embodiment of the present invention,

### DETAILED DESCRIPTION OF THE INVENTION

Exemplary embodiments of the present invention will be described with reference to the accompanying drawings. The present invention is not limited to the embodiments to be disclosed hereinafter, and changes and modifications will become possible within the spirit and scope of the effect that a vibration system integrally includes a spider and diaphragm, and possibly also a surround, and that the spider is located within a voice coil bobbin and attached to a magnetic circuit located, and the voice coil bobbin is suspended in a magnetic gap of the magnetic circuit. In the several views of the drawings, like reference numerals refer to like elements, a detailed description will be omitted, and differences will be explained.

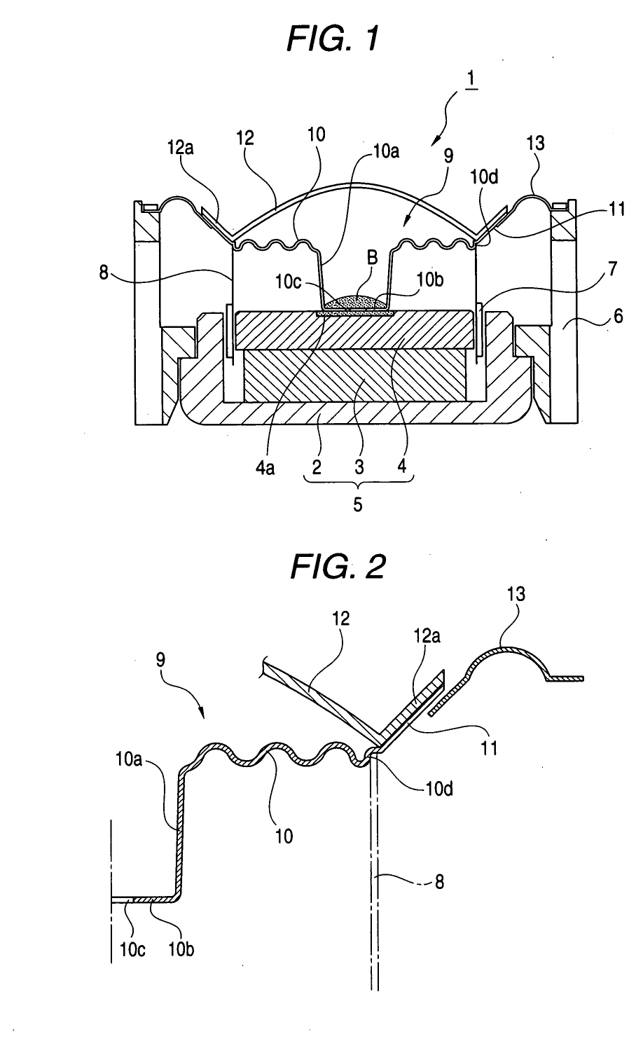

Referring to FIG. 1, a speaker 1 according to a first embodiment of the present invention includes: a magnetic circuit 5 including a pot yoke 2, a magnet 3, and a pole piece 4; a frame 6 attached to the magnetic circuit 5; a voice coil bobbin 8 having a voice coil 7 wound therearound; and a vibration system 9 which is integrally composed of a spider 10 and a diaphragm 11, and which suspends the voice coil bobbin 8 in above the magnetic circuit 5. In this connection, a vibration system generally is meant to extensively include a diaphragm, a voice coil, and a suspension system such as a spider and a surround, but in the description of the present invention, a vibration system is defined to refer specifically to a component integrally composed either of “a spider and a diaphragm”, or of “a spider, a diaphragm, and a surround”. Also, the magnetic circuit 5 shown in FIG. 1 is of an inner magnet type, but the present invention is applicable also to an outer magnet type magnetic circuit, and therefore the pole piece 4 will hereafter be referred to as an upper plate 4.

In the speaker 1 described above, a vibration system is basically formed by integrating a spider and a diaphragm into one component with the spider disposed within a voice coil bobbin, for the purpose of reducing the number of components and enhancing the efficiency of assembly work to thereby improve the productivity and achieve cost reduction, and also for the purpose of surely suspending the voice coil bobbin with respect to the magnetic circuit to thereby achieve a small-size reliable speaker which uses a small-diameter diaphragm but still realizes a broad reproduction bandwidth and withstands a large power input.

Specifically, the vibration system 9 is formed of a breathable material such that a fixing structure 10a shaped in a hollow circular cylinder with a bottom lid 10b is formed at the center of the bottom of the spider 10 having a circular configuration in top plan view, an aperture 10c is formed at the center of the bottom lid 10b, an engaging area 10d adapted to engage with the voice coil bobbin 8 is formed at the outer circumference of the spider 10, and that the diaphragm 11 shaped in a cone is formed at the outer circumference of the engaging area 10d.

A natural fiber or a synthetic fiber, which is breathable, is used for forming the vibration system 9. The diaphragm 11 of the vibration system 9, however, is preferably non-breathable, and is therefore required to be made non-breathable by some method. The method is not subject to any restrictions, but description will be made of the following three methods as examples with reference to FIGS. 2 to 4.

Referring to FIG. 2, one method is performed such that the top surface of the diaphragm 11 shaped conic is totally covered by an outer peripheral portion 12a of a dust cap 12 which is formed of a non-breathable material and disposed over the spider 10. In this method, the outer periphery of the diaphragm 11 is attached to the inner flange of a surround 13 half-rolled and having its outer flange attached to the frame 6. In this connection, the outer peripheral portion 12a of the dust cap 12 preferably has the same width as the diaphragm 11.

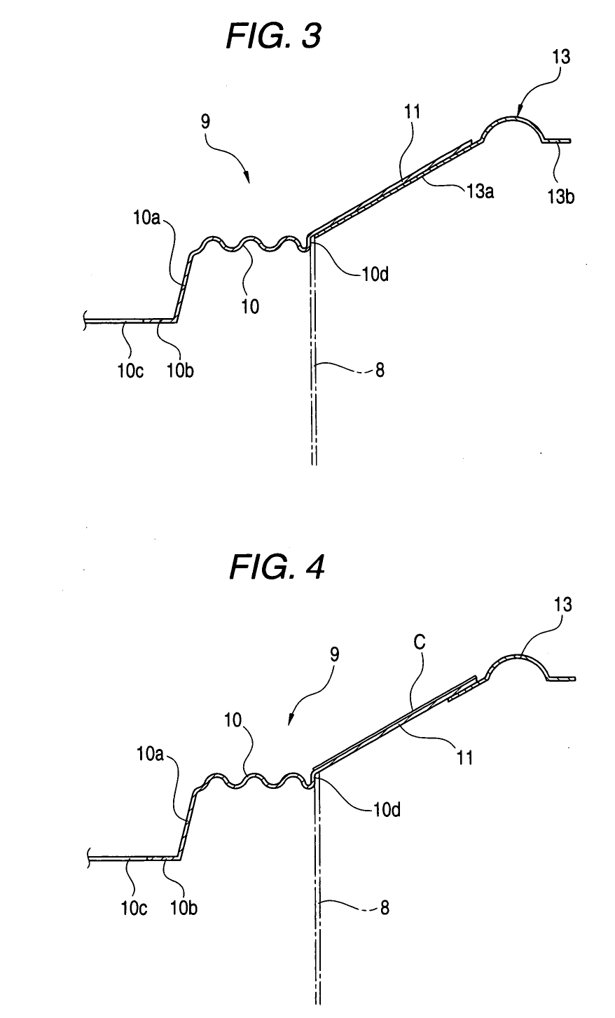

Referring to FIG. 3, another method is performed such that the bottom surface of the diaphragm 1 is totally covered by an inner flange 13a of a surround 13 formed of a non-breathable material. The inner flange 13a of the surround 13 has the same width as the diaphragm 11. In this connection, the inner flange 13a may be disposed so as to cover the top surface of the diaphragm 11. The surround 13 has its outer flange 13b attached to the frame 6.

Referring to FIG. 4, still another method is performed such that resin is applied entirely to the top surface of the diaphragm 11 so as to form a coating layer C for sealing purpose. The resin for sealing is preferably a rubber-based resin such as silicon which keeps flexible even after curing, but when flexibility is not a requisite factor, an emulsion-based adhesive which forms a relatively hard coating may also be used. Thus, there is no particular limitation to the sealing material.

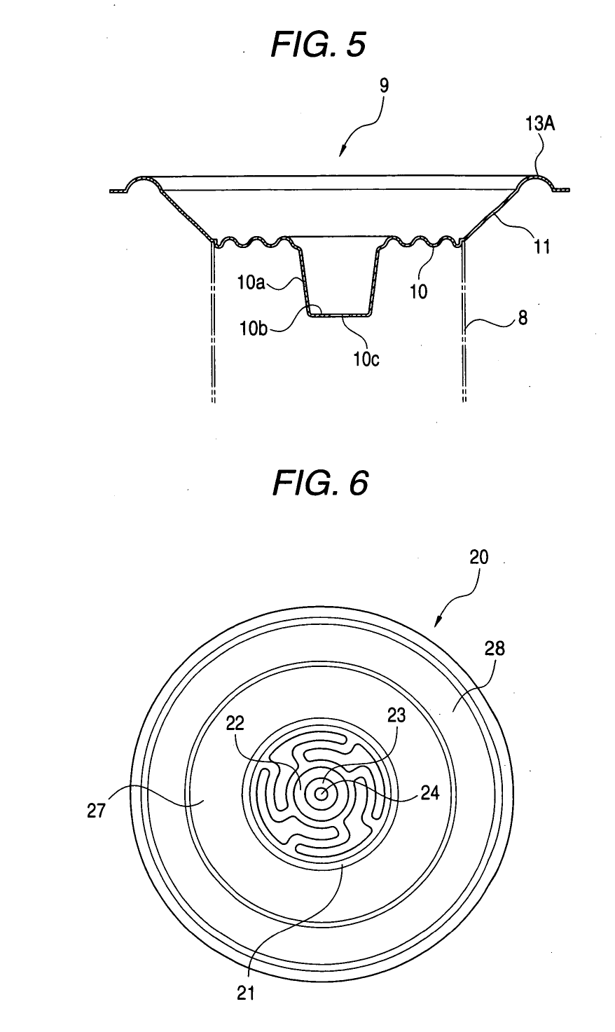

A speaker according to a second embodiment of the present invention will be described with reference to FIG. 5. Referring to FIG. 5, a vibration system 9 in the speaker according the second embodiment is integrally composed of a spider 10, a diaphragm 11, and a surround 13A shaped in a half-rolled configuration. That is to say, the vibration system 9 of FIG. 5 in the second embodiment is structured such that the surround 13A is additionally formed integrally at the outer circumference of the vibration system 9 in FIG. 1 in the first embodiment. Thus, the number of components is further reduced, and production cost reduction is surely achieved. With the reduced number of components, the assembly work of a small-diameter speaker can be made easier, and the productivity is improved.

When the vibration system 9 of FIG. 5 is formed of a breathable material, the diaphragm 11 is preferably either covered by a dust cap of made a non-breathable material, or sealed. In this connection, the vibration system 9 may be made of a resin film instead of the fibers described above, which eliminates application of a sealing treatment to the diaphragm 11, and provides an excellent formability. Such a resin film may be formed of polyetherimide (PEI), polyimide (PI), polyethylene (PE), and the like.

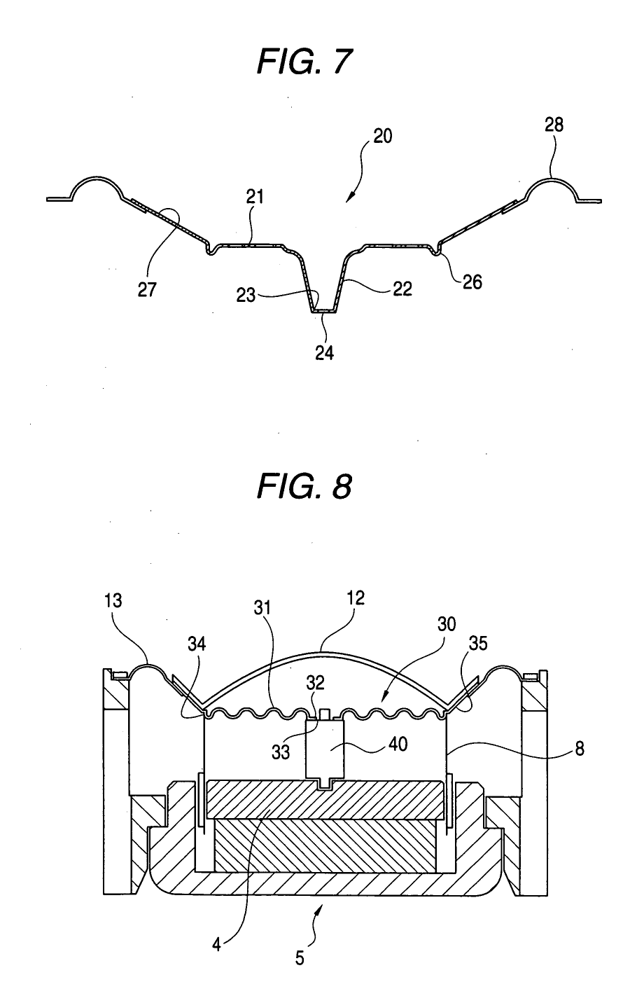

A speaker according to a third embodiment of the present invention will be described with reference to FIGS. 6 and 7. Referring to FIGS. 6 and 7, a vibration system 20 in the speaker according to the third embodiment is integrally structured such that a fixing structure 22 shaped in a hollow circular cylinder with a bottom lid 23 is disposed at the center of the bottom of a spider 21 which has a multi-arm structure, an aperture 24 is formed at the center of the bottom lid 23, an engaging area 26 adapted to engage with a voice coil bobbin is formed at the outer circumference of the spider 21, and that a diaphragm 27 is formed at the outer circumference of the engaging area 26. When the vibration system 20 is formed of a breathable material, the diaphragm 27 is preferably made non-breathable by an appropriate method as described in the explanation of the first embodiment. The vibration system 20 described above is attached to a frame via a surround 28.

A speaker according to a fourth embodiment of the present invention will be described with reference to FIG. 8. Referring to FIG. 8, a vibration system 30 in the speaker according to the fourth embodiment has a plane area 32 at the center of a spider 31, while the vibrations systems 9 and 20 in the preceding embodiments have a fixing structure shaped in a hollow circular cylinder with a bottom lid. An aperture 33 is formed at the center of the plane area 32, an engaging area 34 to engage with a voice coil bobbin 8 is integrally formed at the outer circumference of the spider 31, and a diaphragm 35 is integrally formed at the outer circumference of the engaging area 34. The diaphragm 35 does not need a sealing treatment when the vibration system 30 is integrally formed of a resin film, but is preferably made non-breathable by an appropriate method when the vibration system 30 is integrally formed of a breathable material.

Referring back to FIG. 1, the voice coil bobbin 8 is suspended above the magnetic circuit 5 by the vibration system 9 (or 20) such that the bottom lid 10b of the fixing structure 10a integrally disposed at the spider 10 is fitted into an adhesive chamber 4a formed at the center of the top surface of the top plate 4 of the magnetic circuit 5, whereby an adhesive B applied beforehand in the adhesive chamber 4a partly spreads under the bottom lid 10b and partly goes through the aperture 10c into the fixing structure 10a thus securely fixing the vibration system 9 (20) onto the magnetic circuit 5. In this connection, the voice coil bobbin 8 is adhesively pre-attached to the engaging area 10d formed at the outer circumference of the spider 10.

Referring again to FIG. 8, in case of the vibration system 30, the voice coil bobbin 8 is adhesively attached to the engaging area 34 formed at the outer circumference of the spider 31, then the top of a support member 40 is adhesively attached to the bottom surface of the plane area 32 of the spider 31 with its protrusion part inserted through the aperture 33, and the bottom of the support member 40 is adhesively attached to the top surface of the center of the top plate 4. There is no specific restriction on the configuration of the support member 40 insofar as it includes a part to duly abut on the bottom surface of the plane area 32 of the spider 31. For example, though not illustrated, the support member 40 may be constituted by a screw bolt having, near its top end, a flange-like section which has a flat top surface to fittingly receive the bottom surface of the plane area 32. The top end portion of the screw bolt is inserted through the aperture 33 and engaged with a screw nut to fix the support member 40 to the spider 31 of the vibration system 30, and then the bottom end of the screw bolt is fixedly attached to the top plate 4 of the magnetic circuit 5 by an appropriate method.

As described above, the speaker according to the present invention includes a vibration system that combines a spider and a diaphragm, and possibly also a surround into an integral component formed of a synthetic resin, a resin film, a natural fiber, a synthetic fiber, or any other materials having a similar feature. This reduces the number of components, thus making the speaker assembly work easier and more efficient and further the production cost lower.

Since a hollow cylindrical fixing structure with a bottom lid is formed at the center of the spider of the vibration system with an aperture for secure fixation previously formed at the bottom lid, the vibration system can be securely fixed to the magnetic circuit. Consequently, a wide reproduction frequency bandwidth can be achieved in spite of a small-diameter diaphragm, and the rolling of a vibration system by a large power input can be prevented, thus enabling an effective downsizing of a speaker.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present application claims foreign priority based on Japanese Patent Application No. JP2005-37498 filed on Feb. 15 of 2005, the contents of which is incorporated herein by reference.

What is claime is:

1. A speaker comprising:
a magnetic circuit;
a voice coil bobbin having a voice coil wound therearound; and
a vibration system comprising a spider and a diaphragm, the spider and the diaphragm being combined into an integrated component such that the diaphragm extends radially outwardly from an outer circumference of the spider, wherein the spider is located within the voice coil bobbin, the outer circumference of the spider is fixed to the voice coil bobbin, and a center area of the spider is fixed to a center portion of the magnetic circuit so that the voice coil wound around the voice coil bobbin is suspended in a magnetic gap of the magnetic circuit.

2. A speaker according to claim 1, wherein the outer circumference of the spider is engageable with the voice coil bobbin.

3. A speaker according to claim 1, wherein the diaphragm has a cone configuration.

4. A speaker according to claim 1, wherein the vibration system further integrally comprises a surround extending radially outwardly from an outer circumference of the diaphragm so as to connect between the diaphragm and a part of a frame of the speaker.

5. A speaker according to claim 1, wherein the spider and the diaphragm are integrally formed of one of a synthetic resin, a resin film, a natural fiber, and a synthetic fiber.

6. A speaker according to claim 1, wherein the spider and the diaphragm are integrally formed of a breathable material with the diaphragm structured non-breathable.

7. A speaker according to claim 6, wherein a top surface of the diaphragm is covered by an outer periphery of a dust cap of the speaker, the dust cup being made of a non-breathable material.

8. A speaker according to claim 6, wherein one of a top surface and a bottom surface of the diaphragm is covered by an inner flange of a surround made of a non-breathable material.

9. A speaker according to claim 6, wherein one of a top surface and a bottom surface of the diaphragm is sealed by a rubber-based resin.

10. A speaker according to claim 4, wherein the spider, the diaphragm, and the surround are integrally formed of one of a synthetic resin, a resin film, a natural fiber, and a synthetic fiber.

11. A speaker according to claim 4, wherein the spider, the diaphragm, and the surround are integrally formed of a breathable material with at least the diaphragm structured non-breathable.

12. A speaker according to claim 11, wherein a top surface of the diaphragm is covered by an outer periphery of a dust cap made of a non-breathable material.

13. A speaker according to claim 11, wherein one of a top surface and a bottom surface of the diaphragm is sealed by a rubber-based resin.

14. A speaker according to claim 1, wherein a fixing structure having a hollow circular cylindrical configuration with a bottom lid is formed at a center of a bottom of the spider.

15. A speaker according to claim 14, wherein an aperture is formed at a center of the bottom lid of the fixing structure, so that the spider is securely fixed to the center portion of the magnetic circuit by means of an adhesive applied between the magnetic circuit and the bottom lid of the fixing structure, the adhesive partly flowing into the fixing structure through the aperture of the bottom lid.

16. A speaker according to claim 4, wherein a fixing structure having a hollow circular cylindrical configuration with a bottom lid is formed at a center of a bottom of the spider.

17. A speaker according to claim 16, wherein an aperture is formed at a center of the bottom lid of the fixing structure, so that the spider is securely fixed to the center portion of the magnetic circuit by means of an adhesive applied between the magnetic circuit and the bottom lid of the fixing structure, the adhesive partly flowing into the fixing structure through the aperture of the bottom lid.

18. A speaker according to claim 1, wherein the spider has a plane area at its center area, the plane area having an aperture formed at its center.

19. A speaker according to claim 18, wherein the spider is fixedly attached via a support member to the center portion of the magnetic circuit by leveraging at least one of the plane area of the spider and the aperture formed at the plane area.

20. A speaker according to claim 4, wherein the spider has a plane area at its center area, the plane area having an aperture formed at its center.

21. A speaker according to claim 20, wherein the spider is fixedly attached via a support member to the center portion of the magnetic circuit by leveraging at least one of the plane area of the spider and the aperture formed at the plane area.

22. A speaker comprising:
a magnetic circuit;
a voice coil bobbin having a voice coil wound therearound; and
a vibration system comprising a spider of multi-arm structure and a diaphragm, the spider and the diaphragm being combined into an integrated component such that the diaphragm extends radially outwardly from an outer circumference of the spider, wherein the spider is located within the voice coil bobbin, a fixing structure to be fixedly attached to a center portion of the magnetic circuit is formed at a center of a bottom of the spider, and an engaging area to engage with the voice coil bobbin is formed at the outer circumference of the spider.

23. A speaker according to claim 22, wherein the vibration system further integrally comprises a surround extending radially outwardly from an outer circumference of the diaphragm.
